(19) United States
(12) Patent Application Publication
(10) Pub. No.: US 2007/0013957 A1
(43) Pub. Date: Jan. 18, 2007

(54) Photographing device and method using status indicator

(76) Inventors: Su Jin Kim, Seoul (KR); Sung Sik Wang, Gyeonggi-do (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/454,825

(22) Filed: Jun. 15, 2006

(30) Foreign Application Priority Data
Jul. 18, 2005 (KR) 10-2005-0064775

(51) Int. Cl. H04N 1/23

(52) U.S. Cl. 358/302; 358/1.9

(57) ABSTRACT

A photographing device for photographing an object comprises an image input unit, a signal processing unit and a control unit. In the photographing device, image data of an object generated from the image input unit are analyzed in the signal processing unit, and a status indicator that represents the image quality of the image data is displayed together with a preview image of the object depending on the analysis result in the control unit. As a result, the photographing device previously informs a user of the image quality of a preview image displayed on a screen so that the user may photograph an object in the most appropriate state, thereby preventing re-photographing because of unsatisfactory photographing results.

### BACKGROUND OF THE INVENTION

1. Field of the Invention

The present invention generally relates to a photographing device comprising a camera, and a method thereof. More specifically, the present invention relates to a photographing device that displays an image quality of a preview image of an object sensed through a lens of a camera so that a user can photograph the object in a good image quality using its status information about the image quality.

2. Description of the Related Art

Recently, mobile communication terminals each where a digital camera is built in or removably attached have been widely spread. In these mobile communication terminals, visual communication as well as voice communication is possible. After photographed images are stored in a memory, they are moved into personal computers or transmitted into other mobile communication terminals.

Current mobile communication terminals that have an optical character recognition (card recognition) function recognize characters of the photographed card image and then store the recognized information in a memory. It is not necessary for a user to input characters on the card with a key pad of the mobile communication terminal. However, a conventional mobile communication terminal having the card recognition function has not shown status information (noise) of the preview image before photographing to the user. As a result, the user photographs an object depending on his or her subjective decision.

While the user photographs an object depending on his or her subjective decision, the conventional mobile communication terminal may not recognize information included in the photographed image properly. As a result, the user re-photographs the object inconveniently.

### SUMMARY OF THE INVENTION

The present invention is directed at photographing an object clearly at one time without re-photographing the object inconveniently.

According to one embodiment of the present invention, a photographing device using a status indicator analyzes image data of a photographed object to display a status indicator that represents an image quality of the image data with a preview image of the object.

The photographing device comprises an image input unit configured to sense the object and generate image data of the object, a signal processing unit configured to analyze an image quality of image data generated from the image input unit and generate the status information, and a control unit configured to display the image data generated from the image input unit on the screen and display a status indicator corresponding to status information from the signal processing unit on a predetermined area of the screen.

According to one embodiment of the present invention, a method using a status indicator for photographing an object by a photographing device providing preview image of the object on a screen. The method comprises analyzing image data of the preview image, and displaying a status indicator that represents the image quality of the analyzed image data with the preview image.

### BRIEF DESCRIPTION OF THE DRAWINGS

Other aspects and advantages of the present invention will become apparent upon reading the following detailed description and upon reference to the drawings in which:

FIG. 1 is a diagram illustrating a photographing device using a status indicator according to an embodiment of the present invention;

FIG. 2 is a diagram illustrating an example of a status indicator according to an embodiment of the present invention;

FIG. 3 is a diagram illustrating a signal processing unit of FIG. 1;

FIG. 4 is a flow chart illustrating a method for detecting status information of a current image according to an embodiment of the present invention;

FIG. 5 is a diagram illustrating a preview image and a status indicator displayed in a photographing device according to an embodiment of the present invention;

FIG. 6 is a diagram illustrating photographed characters distinguished and recognized in each area.

### DETAILED DESCRIPTION OF THE EXEMPLARY EMBODIMENTS

The present invention will be described in detail with reference to the accompanying drawings. Wherever possible, the same reference numbers will be used throughout the drawings to refer to the same or like parts.

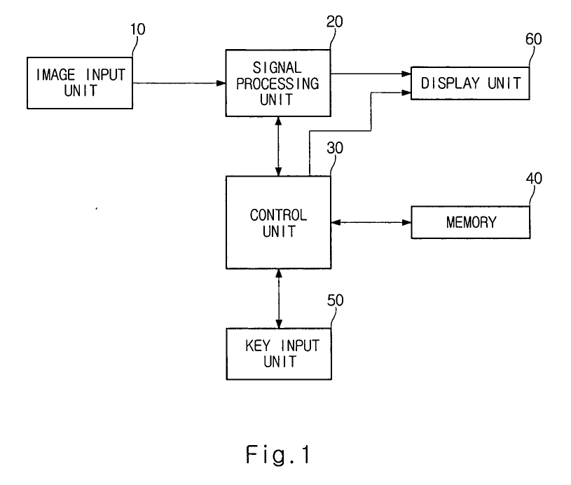

FIG. 1 is a diagram illustrating a photographing device using a status indicator according to an embodiment of the present invention.

The photographing device of FIG. 1 comprises an image input unit 10, a signal processing unit 20, a control unit 30, a memory 40, a key input unit 50 and a display unit (LCD) 60.

The image input unit 10 optically senses an object to be photographed in a camera mode and generates image data of the sensed object to transmit the image data into the signal processing unit 20. In this embodiment, the photographing device can be a mobile communication terminal such as a portable cellular phone. The image input unit 10 fixed or removably attached to the mobile communication terminal includes a camera configured to sense an object optically.

The signal processing unit 20 generates screen data for displaying image data received from the image input unit 10 on a screen to transmit the screen data into the display unit 60. The signal processing unit 20 analyzes the image quality of image data received from the image input unit 10 and transmits the analysis result (status information) into the control unit 30. That is, the signal processing unit 20 signal-processes the image data received from the image input unit 10 to display the image data on the screen and analyze the image quality of the preview image displayed on the screen. For example, when a user uses a card recognition function, the signal processing unit 20 analyzes the recognition rate. i.e. image quality of characters of the card in the current state, and then transmits the analysis result into the control unit 30. The signal processing unit 20 converts RGB data of each pixel in a color image received from the image input unit 1 into YUV data. Then, the signal processing unit 20 analyzes frequency characteristics of Y values which represent a brightness in the converted YUV data to analyze the image quality of the preview image displayed on the screen.

The function of the signal processing unit 20 for converting image data received from the image input unit 10 into screen data to be displayed on the screen has been widely known. The signal processing unit 20 is characterized in that it analyzes the image quality of the preview image to be displayed on the screen and displays the image quality on the screen. Therefore, the function for converting image data into screen data is not explained but the function for analyzing image data is explained in this embodiment.

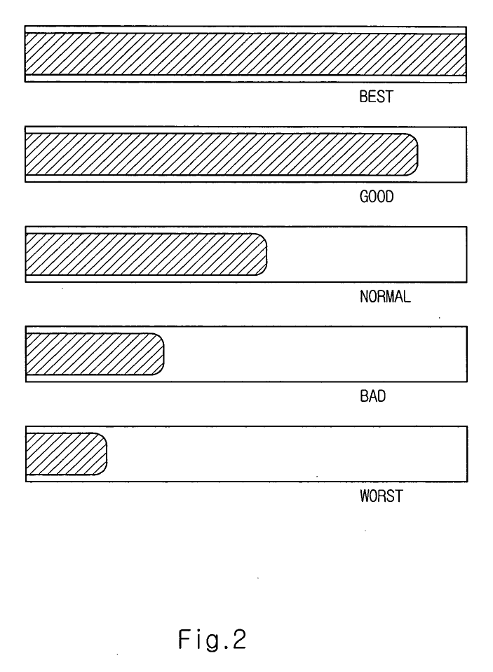

The control unit 30 controls the overall operation of the photographing device. The control unit 30 displays a status indicator that enables a user to watch the image quality of the preview image displayed on the screen depending on status information applied from the signal processing unit 20 on a predetermined area of the screen (the right top of the screen in this embodiment). In this embodiment, as the status indicator displayed on the display unit 60, a progress bar whose size is changed corresponding to the image quality and characters which represents grade of the image quality are displayed on the screen as shown in FIG. 2. The control unit 30 quantifies the degree instead of the progress bar represented by an analog type so as to show the status information of the preview image exactly, and displays the value on the screen. The control unit 30 drives the image input unit 10 to photograph an object when a user applies a photographing command through the key input unit 50, and stores the photographed image in the memory 40. When the status of the photographed image is not good partially, the control unit 30 may be re-photographed selectively on a portion whose recognition state is not good in the entire image depending on user's manipulation through the key input unit 50.

The memory 40 receives and stores the photographed image data from the control unit 30.

The key input unit 50 comprising a plurality of input keys receives a command of the user for manipulating each function of the photographing device such as mode selecting, image photographing and image editing, and transmits the command into the control unit 30.

The display unit 60 displays screen data received from the signal processing unit 20 on the screen (LCD) depending on control of the control unit 30. The display unit 60 displays a status indicator that represents status information of the currently displayed preview image on the screen depending on control of the control unit 30. The display unit 60 displays a charge state and an electric wave receiving state of the photographing device on a predetermined area of the screen.

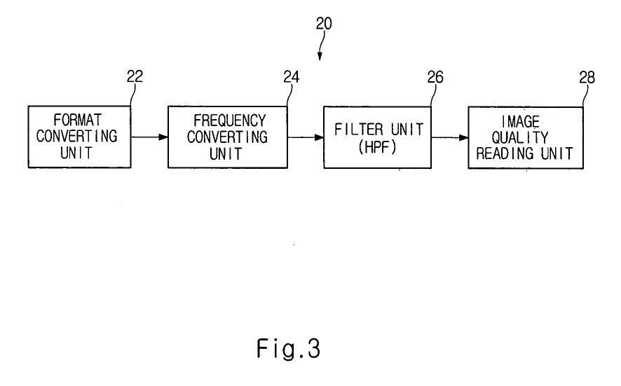

FIG. 3 is a diagram illustrating the signal processing unit of FIG. 1 for displaying the image quality of the image.

In this embodiment, the signal processing unit 20 comprises a format converting unit 22, a frequency converting unit 24, a filter unit 26 and an image quality reading unit 28.

The format converting unit 22 converts RGB data of each pixels of a color image inputted from the image input unit 10 into YUV data, and extracts only Y values that represent a brightness (luminance) from the YUV data to output the Y values into the frequency converting unit 24. When the RGB value is given, the YUV value is Y=0.3R+0.59G+0.11B, U=(B−Y)×0.493, V=(R−Y)×0.877.

The frequency converting unit 24 applies FFT (Fast Fourier Transform) to Y values inputted from the format converting unit 22 to convert the Y values of a time area into functions of a frequency area, thereby grasping frequency characteristics of each Y values.

The filter unit 26 filters signals outputted from the frequency converting unit 24. The filter unit 26 passes signals having a high frequency characteristic in functions of the frequency area changed by the frequency converting unit 24 as a high pass filter HPF, and outputs the passed signals into the image quality reading unit 28.

The image quality reading unit 28 measures the amount of high frequency filtered, and compares a predetermined critical value with the amount to output the comparison result into the control unit 30.

When the Y values that represent a brightness value are converted into a frequency function, a high frequency component represents as a larger boundary edge value and a low frequency component represents as a smaller boundary edge value. Therefore, in this embodiment, after the Y values that represent a brightness value of the image are converted into the frequency area using FFT, the image quality of the preview image displayed on the screen currently can be grasped by finding out how many high frequency components are distributed in the frequency area.

Since any of conventional methods for converting image data applied from the image input unit 10 into screen data to be displayed on the screen can be used, the method is not explained in this embodiment.

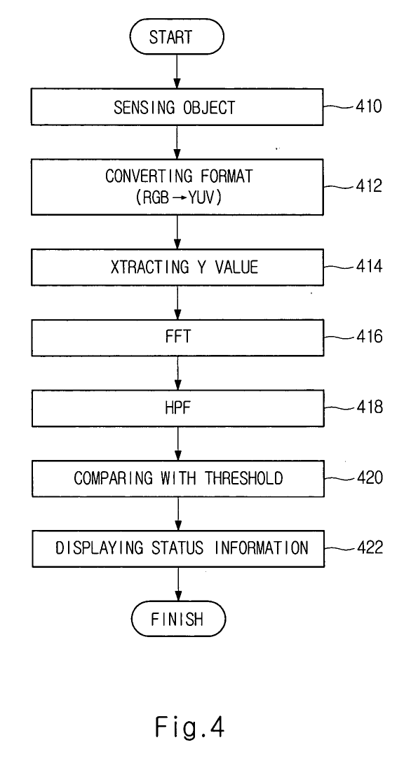

FIG. 4 is a flow chart illustrating a method for detecting status information of a current image according to an embodiment of the present invention.

In this embodiment, a card recognition function using an OCR (optical Character Reader) function of the mobile communication terminal equipped with a camera is mainly described. However, the photographing device according to the embodiment of the present invention can also be applied to other still images or moving images as well as the OCR.

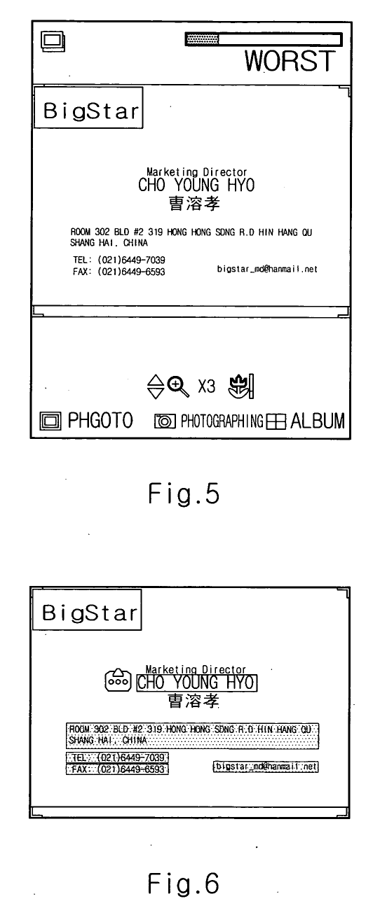

When a user sets up the communication mobile terminal as a camera mode and then selects a ‘character recognition₁₃ photographing’ menu in a camera mode in order to photograph a card to recognize and store the content (character) described in the card, the image input unit 10 senses the image of the object (card) projected through a lens of the camera as shown in FIG. 5, converts the image into image data (digital data), and transmits the image data into the signal processing unit 20 (step 410).

The format converting unit 22 of the signal processing unit 20 converts RGB data of each pixel of image data inputted from the image input unit 10 into YUV data (step 412).

A YUV method that utilizes a characteristic of human eyes sensitive to brightness more than to colors is a color representing method used in TVs. In this YUV method, colors are divided into a Y component which is luminance and U and V component s which are chrominance. Since the Y component is sensitive to errors, the Y component is encoded with the number of bits that is larger than that of bits in the U and V elements. Generally, the ratio of Y:U:V is 4:2:2.

Then, the format converting unit 22 extracts only the Y values that represent the luminance from the YUV data to output the Y values into the frequency converting unit 24 (step 414).

The frequency converting unit 24 applies FFT to Y values in order to grasp a frequency characteristic of the Y values received from the format converting unit 22 to convert Y values of the time area into functions of the frequency area (step 416).

Since the degree of brightness of a color in character recognition photographing is determined depending on the amount of edge values of the character boundary, and the amount of edge values is obtained by analyzing a frequency of the Y values, the Y values of the time area are converted into the frequency area. In other words, when the Y values that represent the luminance are converted into a frequency function, the sensed image having the larger amount of edge values of the character's boundary is displayed as a high frequency element and the sensed image having the smaller amount of edge values of the character's boundary is displayed as a low frequency component.

As a result, an output signals of the frequency converting unit 24 are filtered in the filter unit 26 that is a high pass filter so that only a high frequency component can be extracted from the output signals of the frequency converting unit 24 (step 418).

The image quality reading unit 29 compares the amount of the high frequency filtered in the filter unit 26 with a predetermined threshold value, and outputs the comparison result (status information) into the control unit 30 (step 420).

The control unit 30 displays a status indicator that represents the degree of recognition on the right top of the screen depending on the status information from the image quality reading unit 28 as shown in FIG. 5. In FIG. 5, since the recognition status of characters on the card displayed on the screen is not good, a progress bar having a short length is displayed with characters ‘worst’.

Seeing this status indicator, a user judges whether he will take a photograph of the card in the current state.

When the user pushes a predetermined key in the key input unit 50 to perform a photographing, the image input unit 10 photographs an object (card) in the current state to transmit the photographed image of the card into the control unit 30. The transmitted image is stored in the memory 40.

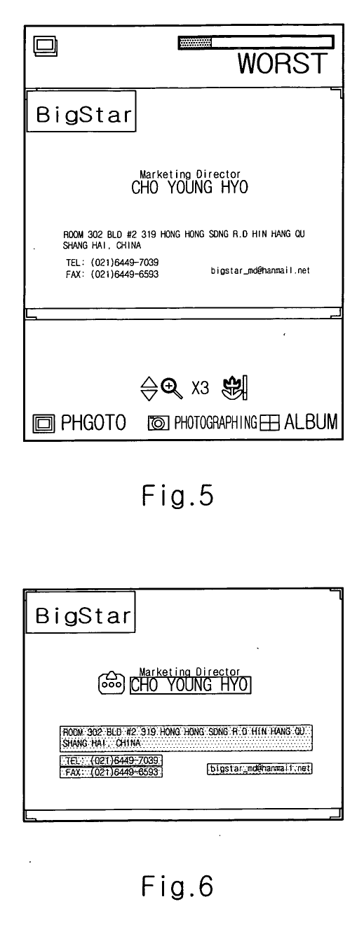

Then, the control unit 30 divides the content (characters) described in the photographed image in to each item and recognizes the content according to each item as shown in a slash line area of FIG. 6. Here, information of a specific area may not be precisely recognized. That is, the status information of the above-described status indicator represents the average recognition degree of the entire preview image. As a result, when the recognition degree is overall high, the status indicator is represented as ‘good’ or ‘best’, and a user performs a photographing in the current state depending on the content of the status indicator. However, the status of the photographed image may not be good partially. For example, of the content of the card, a name, an address, a phone number and a fax number are clearly photographed so that its information is precisely recognized. However, a portion of an email address is unclearly photographed so that the corresponding information is not precisely recognized.

In this way, when there is an undesired one of a plurality of recognized results obtained at one time, the control unit 30 controls the image input unit 10 to perform a photographing only on a corresponding portion when a user applies a photographing command after designating the portion whose image quality is not good using a direction key of the key input unit 50. That is, the re-photographing is not performed regardless of all the previously photographed results, but the re-photographing is performed only on a specific portion whose result is not good.

In the above-described embodiment, RGB data of all pixels of each image frame in image data are converted into YUV data and signal processing is performed on the Y values of the YUV data. However, the signal processing unit 20 samples a predetermined number of pixels of all pixels of each image frame, and then performs the above-described signal processing process (steps 412 through 422) only on the sampled pixels. As a result, it is possible to perform the faster signal processing.

In the above-describe embodiment, the status information of the image is represented as a progress bar which is an analog type. In this case, the degree of the image quality may not be accurately known. As a result, the status information of the image quality can be represented as a numerical value in order to inform the status information more accurately. That is, the control unit 30 predetermines the minimum and maximum values of the image quality, and judges where the status information from the image quality reading unit 28 is located between the maximum value and the minimum value to display a numerical value corresponding to the location on the screen. Here, this numerical value is displayed together with the progress bar as shown in FIG. 2 or only the numerical value may be displayed.

As described above, a photographing device according to an embodiment of the present invention previously informs a user of the image quality of a preview image displayed on a screen before photographing so that the user may photograph an object in the most appropriate state, thereby preventing re-photographing because of unsatisfactory photographing results.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. Thus, the embodiments were chosen and described in order to explain the principles of the invention and its practical application to enable one skilled in the art to utilize the invention in various embodiments and with various modifications as are suited to the particular use contemplated.

What is claimed is:

1. A photographing device using a status indicator configured to analyze image data of a photographed object and display a status indicator that represents an image quality of the image data with a preview image of the object.

2. The photographing device according to claim 1, wherein the photographing device comprises:
an image input unit configured to sense the object and generate the image data of the object;
a signal processing unit configured to analyze the image quality of image data generated from the image input unit and generate status information; and
a control unit configured to display the image data generated from the image input unit on the screen and display the status indicator corresponding to status information from the signal processing unit on a predetermined area of the screen.

3. The photographing device according to claim 2, wherein the signal processing unit converts RGB data of the image data into YUV data and then analyzes frequency characteristics of Y values of the YUV data to analyze the image quality.

4. The photographing device according to claim 3, wherein the signal processing unit converts the Y values into a function of the frequency area and measures the amount of high frequency in the converted frequency area to analyze the image quality.

5. The photographing device according to claim 4, wherein the signal processing unit comprises:
a format converting unit configured to convert the RGB data into the YUV data to extract Y values from the converted YUV data;
a frequency converting unit configured to convert Y values outputted from the format converting unit into function of the frequency area;
a filter unit configured to filter high frequencies from the output signals of the frequency converting unit; and
an image quality reading unit configured to measure the amount of the high frequency outputted from the filter unit and compare the measured amount with a predetermined value to transmit the comparison result into the control unit.

6. The photographing device according to claim 5, wherein the frequency converting unit applies a FFT (Fast Fourier Transform) to the Y values to convert the Y values into the function of the frequency area.

7. The photographing device according to claim 3, wherein the signal processing unit converts RGB data of all pixels corresponding to each frame of the image data into YUV data.

8. The photographing device according to claim 3, wherein the signal processing unit samples a predetermined number of pixels corresponding to each frame of the image data to convert RGB data of the sampled pixels into YUV data.

9. The photographing device according to claim 2, wherein the control unit quantifies the status information to display a progress bar having a length corresponding to the quantity as the status indicator.

10. The photographing device according to claim 9, wherein the control unit displays a figure corresponding to the quantity together with the progress bar.

11. The photographing device according to claim 2, wherein the control unit quantifies the status information to display a figure corresponding to the quantity as the status indicator.

12. The photographing device according to claim 2, wherein the control unit controls the image input unit so as to perform a re-photographing operation selectively only on a specific portion of photographed image having a bad recognition status.

13. A method using a status indicator for photographing an object by a photographing device providing preview image of the object on a screen, the method comprising:
analyzing image data of the preview image; and
displaying a status indicator that represents the image quality of the analyzed image data together with the preview image.

14. The method according to claim 13, wherein the first step comprises:
converting RGB data of the preview image into YUV data; and
analyzing a frequency characteristic of Y values of the YUV data.

15. The method according to claim 14, wherein the frequency analyzing step comprises:
converting the Y values into a frequency area;
measuring the amount of high frequency in the Y values converted into the frequency area to compare the amount with a predetermined threshold value; and
displaying the status indicator corresponding to the comparison result with the preview image.

16. The method according to claim 14, wherein the format converting step comprises converting RGB data of all pixels corresponding to each frame of the image into YUV data.

17. The method according to claim 14, wherein the format converting step comprises sampling only a predetermined number of pixels corresponding to each frame of the image to convert RGB data of the sampled pixels into YUV data.

18. The method according to claim 15, wherein the status displaying step comprises quantifies the comparison result to display the status indicator as a progress bar type having a length corresponding to the quantity.
